(19) United States
(12) Patent Application Publication
(10) Pub. No.: US 2012/0186393 A1
(43) Pub. Date: Jul. 26, 2012

(54) WORKPIECE BRACKET

(76) Inventor: Klaus Hofmann, Bruck (DE)

(21) Appl. No.: 13/499,657

(22) PCT Filed: Sep. 27, 2010
(86) PCT No.: PCT/DE10/75098

§ 371 Date: Mar. 30, 2012

(30) Foreign Application Priority Data
Oct. 2, 2009 (DE) 20 2009 013 241.2

(51) Int. Cl. B23Q 16/06

(52) U.S. Cl. 74/813 L

(57) ABSTRACT

The invention concerns a workpiece console 1, in particular, for machine tools, with an adjusting element 2, which can rotate around an axis Z that preferably runs vertically, and with a flange element 3 for the detachable installation of workpieces or workpiece carriers, wherein the flange element 3 is supported so that it can rotate around a Y axis, which is preferably inclined at a right angle to the Z axis and which preferably runs horizontally, wherein the adjusting element 2 is coupled via a gear 4 with the flange element 3, so as to transfer a rotational movement of the adjusting element 2 to the flange element 3, wherein the workpiece console also comprises a graduated disk 14, which has a division grid 8 and which is coupled nonrotatably with the flange element 3, and an affixing mechanism 5, so as to lock in a detachable manner the graduated disk 14 in a rotational angle position, which can be adjusted by means of the adjusting element 2.

The invention under consideration concerns a workpiece console for the alignment of workpieces, wherein the workpiece console is intended, in particular, for the arrangement in machine tools.

From the state of the art, the need to arrange workpieces in the area of influence of the tools in a machine tool in such a way that they can be processed is known. Since the workpieces must often be processed from different sides, it is necessary to reposition them between specific work steps, so that the side to be processed is accessible to the tool. For this, the state of the art provides special consoles, which together with a workpiece fastened thereon, can swivel by a prespecifiable extent, so that the workpiece is accessible from another side.

The operation of such a console is mostly carried out manually and with regard to adjustment accuracy and the simplest possible handling, the devices known from the state of the art lag behind modern requirements.

The goal of the invention is therefore is to offer a workpiece console to align workpieces in various spatial positions, which is built simply and is easy and safe to operate, and, nevertheless, guarantees a high positioning accuracy.

The goal is attained with a workpiece console in accordance with Claim 1.

The workpiece console in accordance with the invention comprises a flange element on which it is possible to fasten, directly or indirectly, workpieces for processing, wherein this flange element can assume specifiable rotational angle positions. The flange element in accordance with the invention is coupled nonrotatably with a graduated disk, which in turn has a division grid for the definition of the individual partial steps or rotating positions. A fixing element thereby ensures the individually selected rotational angle position of the graduated disk or the flange element coupled thereon. The determination of the desired rotational angle position is carried out via an adjusting element, which is coupled via a gear with the flange element, so that a rotational movement of the adjusting element is transferred to the flange element.

By rotating the adjusting element by a specifiable extent, the flange element is rotated in accordance with the selected gear ratio. During this adjusting process, the fixing mechanism in accordance with the invention releases the graduated disk, so that it can rotate freely together with the flange element. After reaching the desired rotational angle position, the fixing mechanism can work together with the graduated disk so that it retains its rotational angle and thus the workpieces coupled to the flange element reliably retain their rotational position in the space.

An advantageous embodiment of the invention makes provision for the affixing mechanism to be actuatable with the help of the adjusting element. The adjusting element, with which the rotational angle position of the flange element is adjusted, is therefore designed in such a manner that it also causes the release or locking of the graduated disk, in that the adjusting element works together with the gear and also with the affixing mechanism. In this way, it is possible to advantageously guarantee that a change of the rotational angle position of the graduated disk or the flange element by rotation on the adjusting element can take place only if the adjusting element simultaneously triggers the locking of the graduated disk. Conversely, the adjusting element is also able to cause the affixing mechanism to lock the graduated disk, so that a change of the rotational angle position after this time is mechanically hindered and thus can be ruled out.

Therefore, two functions are simultaneously correlated with the adjusting element in accordance with the invention—namely, the adjustment of the rotational angle and the release/locking of the graduated disk. In this way, operating errors of the workpiece console (change of the rotational angle with a locked graduated disk) and damage to the workpiece console resulting therefrom are advantageously avoided.

A workpiece console in accordance with the invention thereby comprises an adjusting element, which can rotate around a preferably vertically running Z axis, and a flange element for the detachable installation of workpieces or workpiece carriers. The flange element is thereby rotatably supported around a preferably horizontally running Y axis, preferably inclined at a right angle to the Z axis, and is nonrotatably coupled with a graduated disk, which in turn has a division grid. The adjusting element is coupled with the flange element via a gear, so that a rotational movement of the adjusting element can be transferred to the flange element. A fastening mechanism, which is actuatable with the aid of the adjusting element, can lock the graduated disk in a selected rotational angle position or release it to change the rotational angle.

A particularly advantageous embodiment of the workpiece console makes provision for the affixing mechanism to be actuatable by means of the adjusting element, in that it is shifted in the Z direction—preferably, against an elastic force—from a position of rest into a working position or vice-versa. A rotational movement of the adjusting element around its Z axis then brings about the change of the rotational angle position of the flange element, whereas the movement in the direction of the Z axis causes the affixing mechanism to release or lock the graduated disk.

The advantage of this embodiment is to be found in that actuation of the workpiece console is possible very simply and safely, for example, with the aid of an actuation pin carried by a tool holder. The rotation of the adjusting element takes place thereby by means of an especially horizontal movement of the actuation pin (horizontal X-Y plane), whereas the actuation of the affixing mechanism takes place by means of the vertical movement of the actuation pin in the Z direction. The two movements can take place independently of one another.

In a particularly preferred variant of the workpiece console, the affixing mechanism comprises a pawl, which is preferably acted on by a spring and which, in a locking position with a locking element, meshes into the division grid of the graduated disk, and which after deflection from the locking position into a release position, triggers the locking of the graduated disk. The pawl can, in particular, be designed like a lever supported on the end, whose opposite free end can swivel by a prespecified extent between two stops, wherein the stops define the locking position and the release position of the pawl. A locking element, for example, a projection provided on the pawl, works together in the locking position with the division grid in a friction-locking or, in particular, in a form-locking manner.

Such a pawl can be operated very simply, for example, with the aid of a cam acting on the pawl. A rotation of the cam, for example, by 180°, could thereby move the pawl from the locking position against a spring force into the release position, so as to make possible in this way the change of the rotational angle position of the flange element.

In a particularly advantageous way, in the sense of the invention, this pawl guarantees also the possibility of being acted on by the adjusting element directly or indirectly, for example, by a plunger that can move in the Z direction, or another element with the same function. The plunger could be a component of the adjusting element or be connected to it. Then, with the actuation of only one component—namely, the adjusting element—the locking of the graduated disk can first be triggered (shift of the adjusting element into a vertical direction), and subsequently by rotation of the adjusting element, can be moved to the desired new rotational angle position. A permanently maintained, nonrotatable connection between the adjusting element and screw guarantees that the rotational position of the adjusting element remains unchanged during the processing of the workpieces. A meshing pattern advantageously placed on the adjusting element for operation with an actuation pin (recesses 12; in this regard see further below) then also retains its position defined, so that the position of the recesses for other subsequent actuations with the actuation pin remains clear and a movement can be made there in a precise manner.

For the particularly simple operation of the adjusting element, another embodiment of the invention provides for the adjusting element to have recesses (meshing pattern) that are located in a regular manner on a graduated circle on its upper side open upwards in the Z direction. An actuation pin held, in particular, by a tool holder can be introduced from above into these recesses in the Z direction, so as to bring about in this way a form-locking connection with the adjusting element in the X-Y plane. To rotate the adjusting element, the actuation pin can then be conducted in a (preferably, circular) movement in the X-Y plane, so that the pin, which meshes into the adjusting element, rotates around its Z axis in accordance with this circular movement.

A special embodiment of the workpiece console in accordance with the invention guarantees that a change of the rotational angle position of the flange element is reliably prevented with a locked graduated disk, as a result of a special coupling of the adjusting element with the affixing mechanism. An actuation of the gear will therefore be able to take place only if the graduated disk is released for rotation or the pawl of the affixing mechanism has assumed the release position. Therefore, a special embodiment of the invention makes provision so that the adjusting element for the transfer of its rotational movement to the flange element can be connected with a gear element. In particular, the adjusting element could have a splined shaft connection, which can bring about a nonrotatable connection with a worm gear. Appropriately, the nonrotatable connection is brought about if the graduated disk is or was released for rotation. Otherwise, therefore, as long as the graduated disk is locked in its rotational position, a transfer of the rotational movement of the adjusting element to the gear or a gear element will reliably fail to occur.

This goal can be attained in a particularly elegant manner in accordance with the invention in that the nonrotatable connection is brought about if the adjusting element is shifted in the Z direction to the extent that in this case, it simultaneously acts on the affixing mechanism for the release of the graduated disk. In particular, a screw, which is arranged so it can rotate around the Z axis of the adjusting element, is conceivable, and its axis is formed by a shaft section of the adjusting element. The shaft section should thereby be movable relative to the screw in the Z direction, so that depending on the Z position, a nonrotatable connection between the shaft section and the screw is brought about or detached.

This produces the advantage in accordance with the invention that a transfer of the rotational movement of the adjusting element to the gear or to the flange element is reliably possible only if the nonrotatable connection between the adjusting element and screw is brought about. At the same time, this movement of the adjusting element in the Z direction (to produce the nonrotatable connection), however, can also be used in accordance with the invention to act on the pawl of the affixing mechanism, so that the locking of the graduated disk is detached. The change of the rotational angle position of the flange element can therefore take place, according to this embodiment, only if the graduated disk is in fact not locked. By means of this coupling capacity of the adjusting element with the gear on the one hand, and the affixing mechanism on the other hand, an improper operation of the workpiece console can be advantageously ruled out.

Since the adjusting element in accordance with the preceding variant in the position at rest can be rotated freely in theory, the recesses of the meshing pattern on the upper side of the adjusting element could change their position, for example, during the processing of a workpiece, and assume an indeterminate position or one not “known” to the machine. Then, the actuation pin could subsequently not be introduced into a recess with reliable accuracy, which complicates the automatic or mechanical operation of the workpiece console. Therefore, another embodiment variant of the adjustment element makes provision for the upper adjusting element section, containing the meshing pattern and provided with recesses, to be conducted into a defined rotational position around the Z axis, if the adjusting element, proceeding from the lower work position, is conducted into the upper position at rest.

Appropriately, this positioning takes place only if during the upward movement of the adjusting element, the nonrotatable connection to the screw was detached. For the positioning, for example, a locking in the area of the support of the adjusting element would be taken into consideration, into which a positioning element located nonrotatably on the adjusting element forcibly meshes during the upward movement and which thereby transfers the positioning element together with the adjusting element into the defined rotational position. The defined rotational position is thereby preferably to be selected or specified in such a manner that it either coincides precisely with the rotational position of the adjusting element immediately after the adjustment of the rotational angle of the flange element or lies rotated precisely one or more recesses relative to it.

A particularly simple or clear operation of the workpiece console by the adjusting element is produced if precisely one division step of the division grid on the graduated disk corresponds to a division step of the recesses of the adjusting element. If the adjusting element in this case is turned by precisely one division step (so that a recess arrives up to the position of the previously directly adjacent position), then the division grid should also be further turned by precisely one graduated step on the graduated disk. If the adjusting element, for example, has 12 recesses distributed uniformly over the circumference and the division grid comprises 144 individual graduated positions on the division grid, then one rotation of the adjusting element by 1/12 (that is, 30°) would correspond to one rotation of the graduated disk or of the flange element by 1/144 (that is, 2.5°). A particularly appropriate gear ratio between the adjusting element and the flange element is therefore 12:1. With 12 recesses in the adjusting element and a gear ratio of 12:1, rotational angles of the flange element in 2.5° steps are possible. In this way, for example, rotational angles of 90°, 45°, or also 22.5° can be featured, which would not be possible with division steps of 1° on the graduated disk.

As mentioned in the beginning, the workpiece console is suitable for the alignment of related workpieces in various rotational angle positions. In order to be able to fasten the workpieces suitably, a preferred embodiment of the workpiece console in accordance with the invention makes provision for a clamping beam, which can be connected with the flange element. The clamping beam is used to fasten, in particular, several workpieces and comprises several fastening surfaces, which run parallel to the Y direction and which form relative to one another an angle of preferably 90°. On each of these surfaces, it is possible in accordance with the invention to fasten one or more workpieces. By rotating the clamping beam via the mechanism in accordance with the invention that is described in the preceding, the workpieces fastened on each surface of the clamping beam each assume a new processing position, so as to be subsequently processed.

Other advantageous embodiments can be deduced from the subordinate claims.

An embodiment in accordance with the invention will be explained in more detail below with the aid of figures. The figures show the following:

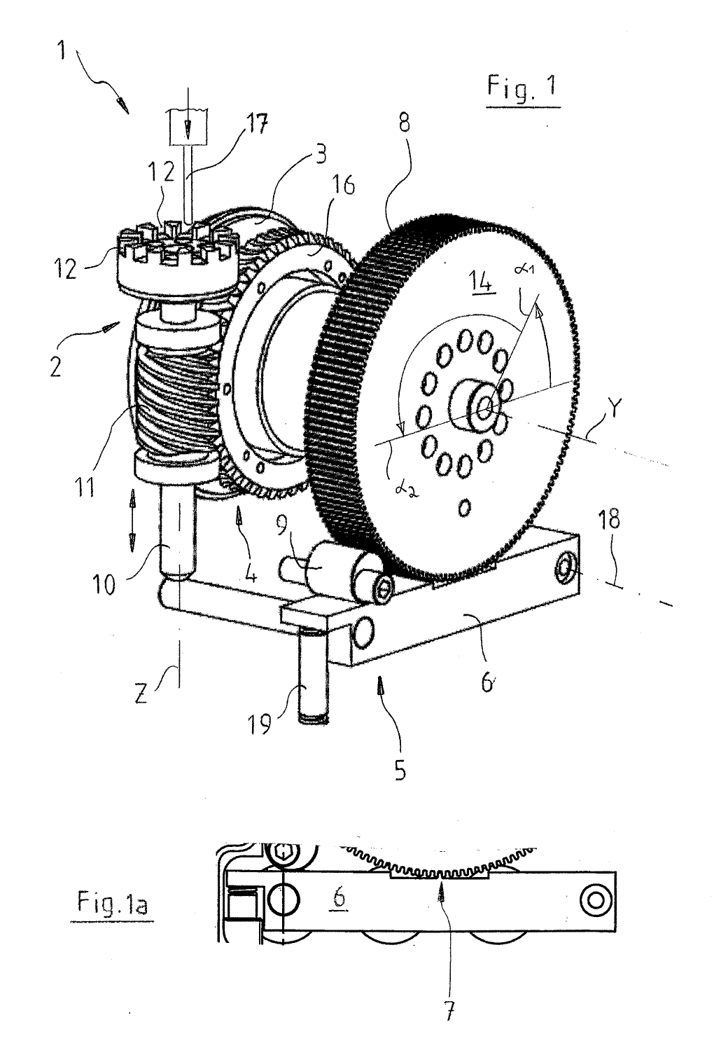

FIG. 1, a schematic, perspective view of essential components of the workpiece console;

FIG. 1A, an enlarged section of a side view of the graduated disk locking;

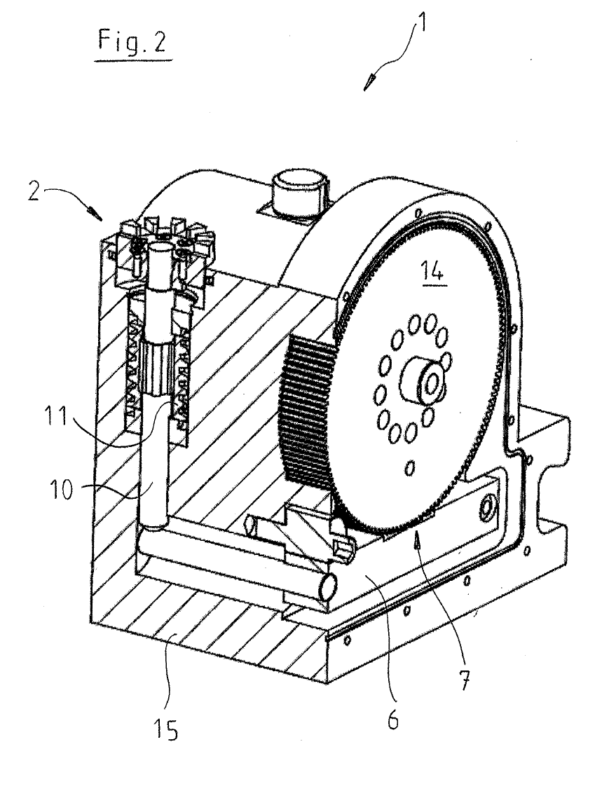

FIG. 2, a schematic, perspective sectional representation of a workpiece console in the housing; and

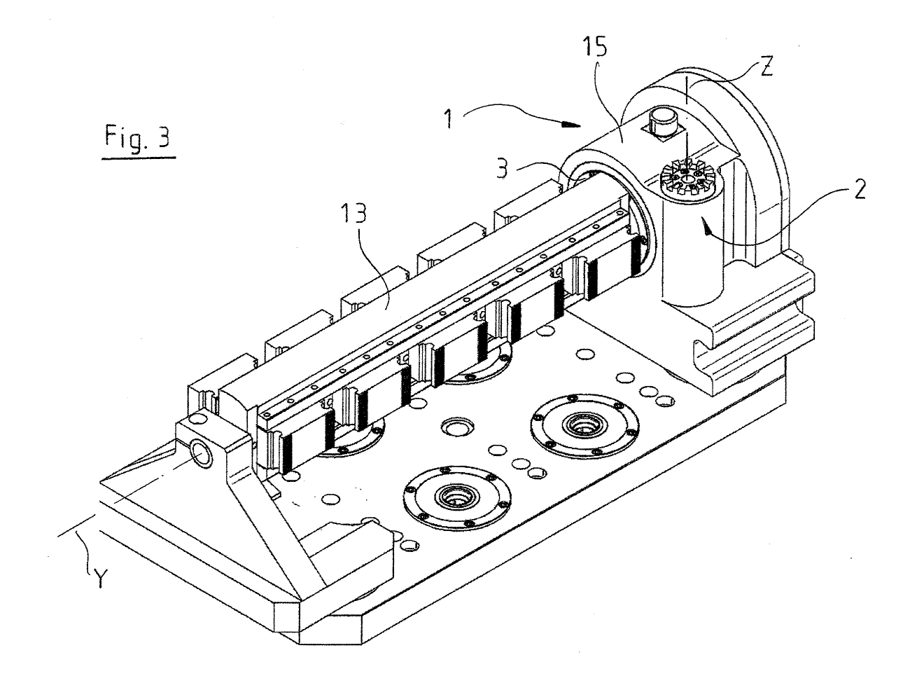

FIG. 3, a workpiece console with clamping beams to hold workpieces.

FIG. 1 shows a workpiece console 1 in a perspective, partial view. The graduated disk 14, the worm gear 16, and the flange element 3 are connected nonrotatably with one another on a horizontal Y axis, and supported in a rotatable manner around the Y axis. The flange element 3 is used to fasten workpieces or workpiece carriers, which will be transferred for various processing steps into various rotational angle positions α₁ and α₂ represented only by way of example in FIG. 1.

A screw 11 meshes with the worm gear 16, and is centrically penetrated by a plunger 10. The plunger 10 is a part of an adjusting element 2, which is supported in a rotatable manner around a vertical Z axis, and has several recesses 12 on its upper end, into which an actuation pin 17 shown schematically can mesh from above. The adjusting element 2 is supported so that it can be displaced in the Z direction and can be moved from an upper position at rest to a lower working position. A rotational movement imposed on the adjusting element brings about (in this variant, independent of the position of the adjusting element 2) a rotation of the flange element 3, as a function of the rotational angle of the adjusting element 2, via the gear unit 4 formed from the screw 11 and the worm gear 16.

The plunger 10 of the adjusting element 2 acts on the pawl 6 of an affixing mechanism 5. The pawl can swivel around a horizontal axis 18 between a locking position and a release position, wherein the plunger 10, during the upward movement of the adjusting element 2 from the position at rest into the working position, presses down the pawl from the locking position into the release position. If, on the other hand, the adjusting element 2 moves back into the upper position at rest, then the pawl 6 is pressed back into the locking position via the spring 19.

FIG. 1a shows in an enlarged partial view how a locking element 7 located on the pawl 6 meshes into a graduated grid 8 located on the graduated disk 14, so that a rotation of the graduated disk 14 (and thus also of the flange element 3) is avoided in the locking position by form-locking.

Supplementary to the actuation of the affixing mechanism 5, via the adjusting element 2, the pawl 6 can also be moved manually via a cam 9 from its locking position, against the force of the spring 19, into the lower release position.

The workpiece console functions in the following manner: in the upper position at rest of the adjusting element 2, the pawl 6 is in the locking position so that a rotation of the flange element 3 is impossible.

If the rotational angle position of the flange element 3 should be changed, then the adjusting element 2 is first pressed down from the upper position at rest into the lower working position with the aid of the actuation pin 17, which is introduced into one of the recesses 12 of the adjusting element 2. The plunger 10 thereby presses the pawl 6 of the affixing mechanism 5 from the locking position into the release position, so that the locking element 7 is no longer meshed with the division grid 8 on the graduated disk 14. Now, the actuation pin 17—in accordance with the desired rotational angle—moves on a circular path around the Z axis. The screw 11 connected nonrotatably with the adjusting element 2 then brings via the worm gear 16 the rotation of the flange element 3 to the desired extent, wherein the smallest selectable rotationable angle change, in this example, of a further movement of the division grid 8 relative to the locking element 7 corresponds to exactly one graduated step.

As soon as the desired rotational angle position of the flange element is adjusted, the actuation pin 17 is again lifted upwards in a vertical direction. The adjusting element 2 is thereby moved from the working position to the position at rest. In this way, the pawl 6 is able to follow the upward movement of the plunger 10, so that the locking element 7 can mesh into the newly selected position on the division grid 8 and can affix the graduated disk 14 in a nonrotatable manner. In a previously described variant, a nonrotatable connection between the adjusting element 2 and screw 11 could be brought about or detached during the movements into the working position or the position at rest.

The mechanism in accordance with the invention reliably prevents a rotation of the flange element 3 by the affixed graduated disk 14.

FIG. 2 shows the components in accordance with FIG. 1 arranged in a cut-out housing 15. Here, one can see somewhat better the splined shaft connection between the screw 11 and the adjusting element 2, which in this case always offers a nonrotatable connection to the screw 11 independent of the Z position of the adjusting element 2.

FIG. 3 shows an application case of the workpiece console 1 in accordance with the invention. The console 1 is located on a machine base of a machine tool, wherein the console is advantageously fixed on the machine base via a zero clamping system, which is not described in more detail. A clamping beam 13 is located on the flange element 3, and extends in the Y direction and can be turned around the Y axis together with the flange element 3. This is supported at the end of the clamping beam 13 opposite the workpiece console. Several workpieces can be affixed on various sides of the clamping beam 13 and can be processed there. After the completion of the processing of the workpieces at an initially selected rotational angle position of the flange element 3, the rotatonal angle position can be changed according to the previously described method via the adjusting element 2, so that the workpieces then assume another alignment in the space, so as to be subsequently further processed.

1. Workpiece console (1), in particular, for machine tools,
a) with an adjusting element (2), which can rotate around an axis (Z), which preferably runs vertically; and
b) with a flange element (3) for the detachable installation of workpieces or workpiece carriers, wherein the flange element (3) is supported so it can rotate around a Y axis, which preferably inclines at a right angle to the Z axis and which preferably runs horizontally;
c) in that the adjusting element (2) is coupled with the flange element (3) via a gear (4), so as to transfer a rotational movement of the adjusting element (2) to the flange element (3);
characterized in that the workpiece console also comprises
d) a graduated disk (14), which has a division grid (8) and which is coupled in a nonrotatable manner with the flange element (3); and
e) an affixing mechanism (5);
so as to lock in a detachable manner the graduated disk (14) in a rotational angle position, which can be adjusted by means of the adjusting element (2).

2. Workpiece console according to the preceding claim, characterized in that the affixing mechanism (5) can be actuated with the adjusting element (2).

3. Workpiece console according to the preceding claim, characterized in that the affixing mechanism (5) can be actuated by the adjusting element (2) in that it is moved in the Z direction from a position at rest to a working position or vice-versa.

4. Workpiece console according to one of the preceding claims, characterized in that the affixing mechanism (5) comprises a pawl (6), which is preferably acted on by a spring, and
a) which in a locking position with a locking element (7), meshes into the division grid (8) in a locking manner;
b) and which after deflection from the locking position to a release position, releases the locking of the graduated disk (14).

5. Workpiece console according to the preceding claim, characterized in that the pawl (6) can move between the locking and release positions via a manually operatable cam (9) and/or a plunger (10) connected with the adjusting element (2).

6. Workpiece console according to one of the preceding claims, characterized in that the adjusting element (2) is connected or can be connected with a gear element (11), in particular, a screw (11), for the transfer of its rotational movement to the flange element in a nonrotatable manner, in particular, by means of a splined shaft connection.

7. Workplace console according to claims 3 and 6, characterized in that the nonrotatable connection can be effected by movement of the adjusting element (2) into the working position and can be detached by movement into the position at rest.

8. Workplace console according to one of the preceding claims, characterized in that guiding means are provided so as to transfer the adjusting element (2), upon the assuming of the position at rest, into one of preferably several rotational positions defined by the guiding means.

9. Workpiece console according to one of the preceding claims, characterized in that the adjusting element (2) has recesses (12), which are open upwards, in the Z direction and are located regularly on a graduated circle, so as to accept an actuation pin (17), preferably held by a tool holder of a machine tool, into one of the recesses (12) for the actuation of the adjusting element (2).

10. Workpiece console according to the preceding claim, in which the gear ratio is selected in such a manner that exactly one division step of the division grid (8) corresponds to one division step of the recesses (12) of the adjusting element (2).

11. Workpiece console according to one of the preceding claims, characterized in that the gear ratio of the adjusting element (2) to the flange element (3) is 12:1.

12. Workpiece console according to one of the preceding claims, characterized in that a clamping beam (13) is provided for the connection with the flange element (3), wherein the clamping beam (13) has several fastening surfaces running parallel to the Y direction for the fastening of workpieces, which form relative to one another an angle, preferably, of 90°.
